(19) United States
(12) Patent Application Publication
(10) Pub. No.: US 2020/0165444 A1
(43) Pub. Date: May 28, 2020

(54) LIQUID CRYSTALLINE POLYESTER RESIN COMPOSITION AND MOLDED PRODUCT PRODUCED THEREFROM

(71) Applicant: Toray Industries, Inc., Tokyo (JP)

(72) Inventor: Koji Tachikawa, Nagoya-shi (JP)

(21) Appl. No.: 16/613,173

(22) PCT Filed: May 8, 2018
(86) PCT No.: PCT/JP2018/017809

§ 371 Date: Nov. 13, 2019

(30) Foreign Application Priority Data
Jun. 14, 2017 (JP) 2017-116778
Oct. 17, 2017 (JP) 2017-201082

(51) Int. Cl. C08L 67/04; C08G 63/60; C08K 3/36; C08K 7/18; C08K 9/06

(52) U.S. Cl. CPC C08L 67/04; C08G 63/605; C08K 3/36; C08L 2205/12; C08K 9/06; C08G 2250/00; C08K 2201/005; C08K 7/18

(57) ABSTRACT

A liquid crystalline polyester resin composition contains 10-45 parts by weight of a surface-hydrophobized spherical silica (B) with respect to 100 parts by weight of a liquid crystalline polyester res-in (A); and a molded article obtained from the liquid crystalline polyester resin composition. The liquid crystalline polyester resin composition may also contain 1 to 2.5 parts by weight of an ethylene/glycidyl methacrylate copolymer (C) with respect to 100 parts by weight of a resin composition consisting of the liquid crystalline polyester resin (A) and the surface-hydrophobized spherical silica (B). The liquid crystalline polyester resin composition has excellent sliding characteristic, adhesive characteristic and impact durability; and a molded product obtained from the liquid crystalline polyester resin composition.

### TECHNICAL FIELD

This disclosure relates to a liquid crystalline polyester resin composition and a molded product produced therefrom, excellent in sliding characteristic with improved adhesion strength and impact durability.

### BACKGROUND

Technological advances of plastic are increasingly demanded to develop various resins having a new performance to be offered on the market. Above all, liquid crystalline polyester resins having an optical anisotropy characterized by parallel sequences of molecular chain attract attention on their excellent heat resistance, mechanical property and dimensional stability suitable for a precision molded product such as fine connectors.

The precision molded product having small terminals and clearances may have a connection failure between terminals or a driving obstructed by fine dust in the clearance generated by sliding the surface of molded product.

To solve such a problem, JP 2010-106165 A discloses a liquid crystalline resin blended with fine silica to improve raised fabric surface area while JP 2011-68831 A and JP 6190089 B disclose studies to reduce released substances.

JP 2006-299254 A, JP 2003-253097 A, JP 2011-63699 A and WO 2007/043701 disclose effects of improving heat resistance and impact strength by blending liquid crystalline resin with such fine silica. In JP '254, a film with improved heat resistance and dimensional stability has been obtained by employing fine silica having functional groups on the surface. In JP '097, a composition with improved heat-resistant, dimensional stability and chemical resistance has been obtained by employing silica having a bimodal particle diameter distribution. In JP '699, a composition with improved impact strength and heat resistance has been obtained by employing fine powder of 0.1-1 μm diameter and filler of 20-300 μm. In WO '701, a composition with improved surface impact resistance has been obtained by employing powdery filler having average particle diameter of 0.2-2 μm together with a copolymer of α-olefin or styrene and α,β-unsaturated glycidyl ester.

The compositions obtained as described above do not have a sliding characteristic sufficient for the latest fine sliding component parts.

Because the fine sliding component parts are hardly provided with a mechanical coupling structure, it has to be bonded to metal, glass or the like to join them. However, the sliding characteristic and adhesiveness cannot be achieved at the same time because of the trade-off between great surface roughness for a good adhesive strength and a bad sliding characteristic.

Further, the compositions obtained as described above do not have a durability sufficient for a mechanism subject to repetitive impacts in which a sliding compartment part stops by hitting another compartment part.

Accordingly, it could be helpful to provide a liquid crystalline polyester resin composition having excellent sliding characteristic, adhesiveness, and impact durability and a molded product obtained therefrom.

### SUMMARY

We blend a predetermined amount of hydrophobic surfaced spherical silica with liquid crystalline polyester resin. We thus provide a liquid crystalline polyester resin composition containing hydrophobic surfaced spherical silica (B) of 10 to 45 parts by weight to liquid crystalline polyester resin (A) of 100 parts by weight.

Our liquid crystalline polyester resin composition has excellent sliding characteristic, adhesiveness, and impact durability and a molded product obtained therefrom.

### DETAILED DESCRIPTION

Our liquid crystalline polyester resin (A) comprises structural a unit such as aromatic carbonyl unit, aromatic and/or aliphatic dioxy unit and aromatic and/or aliphatic dicarbonyl unit, forming an anisotropic melt phase.

The aromatic oxycarbonyl unit may be a structural unit generated from p-hydroxy benzoate, 6-hydroxy-2-naphthoic acid or the like. It is preferable to employ the unit generated from p-hydroxy benzoate. The aromatic and/or aliphatic dioxy unit may be a structural unit generated from 4,4′-dihydroxy biphenyl, hydroquinone, 3,3′,5,5′-tetramethyl-4,4′-dihydroxy biphenyl, t-butyl hydroquinone, phenyl hydroquinone, 2,6-dihydroxynaphthalene, 2,7-dihydroxynaphthalene, 2,2-bis(4-hydroxyphenyl) propane, 4,4′-dihydroxy diphenyl ether, ethylene glycol, 1,3-propylene glycol, 1,4-butanediol or the like. It is preferable to employ the structural unit generated from 4,4′-dihydroxy biphenyl or hydroquinone. The aromatic and/or aliphatic dicarbonyl unit may be a structural unit generated from terephthalic acid, isophthalic acid, 2,6-naphthalenedicarboxylic acid, 4,4′-diphenyl dicarboxylic acid, 1,2-bis(phenoxy) ethane-4,4′-dicarboxylic acid, 1,2- bis(2-chlorophenoxy) ethane-4,4′-dicarboxylic acid, 4,4′-diphenyl ether dicarboxylic acid, adipic acid, sebacic acid or the like. It is preferable to employ the structural unit generated from terephthalic acid or isophthalic acid.

The liquid crystalline polyester resin may be: a liquid crystalline polyester resin, comprising structural unit generated from p-hydroxybenzoate and a structural unit generated from 6-hydroxy-2-naphthoic acid; a liquid crystalline polyester resin, comprising a structural unit generated from p-hydroxybenzoate, a structural unit generated from 6-hydroxy-2-naphthoic acid, a structural unit generated from aromatic dihydroxy compound, and a structural unit generated from aromatic dicarboxylic acid and/or aliphatic dicarboxylic acid; a liquid crystalline polyester resin, comprising a structural unit generated from p-hydroxybenzoate, a structural unit generated from 4,4′-dihydroxy biphenyl, and a structural unit generated from aromatic dicarboxylic acid such as terephthalic acid and isophthalic acid and/or aliphatic dicarboxylic acid such as adipic acid and sebacic acid; a liquid crystalline polyester resin, comprising a structural unit generated from p-hydroxybenzoate, a structural unit generated from 4,4′-dihydroxy biphenyl, a structural unit generated from hydroquinone, and a structural unit generated from aromatic dicarboxylic acid such as terephthalic acid and isophthalic acid and/or aliphatic dicarboxylic acid such as adipic acid and sebacic acid; a liquid crystalline polyester resin, comprising a structural unit generated from p-hydroxybenzoate, a structural unit generated from ethylene glycol, and a structural unit generated from terephthalic acid and/or isophthalic acid; a liquid crystalline polyester resin, comprising a structural unit generated from p-hydroxybenzoate, a structural unit generated from ethylene glycol, a structural unit generated from 4,4′-dihydroxy biphenyl, and a structural unit generated from terephthalic acid and/or aliphatic dicarboxylic acid such as adipic acid and sebacic acid; a liquid crystalline polyester resin, comprising a structural unit generated from p-hydroxybenzoate, a structural unit generated from ethylene glycol, a structural unit generated from aromatic dihydroxy compound, and a structural unit generated from aromatic dicarboxylic acid such as terephthalic acid, isophthalic acid and 2,6-naphthalenedicarboxylic acid; or a liquid crystalline polyester resin, comprising a structural unit generated from 6-hydroxy-2-naphthoic acid, a structural unit generated from 4,4′-dihydroxy biphenyl, and a structural unit generated from 2,6-naphthalenedicarboxylic acid.

From a viewpoint of low dust generation, it is preferable that the liquid crystalline polyester resin comprises units (I), (II), (III), (IV) and (V) as described below. Such a liquid crystalline polyester resin can be prevented from fibrillating that is one of characteristics of liquid crystalline polyester resin because of many copolymer units to decrease liquid crystallinity.

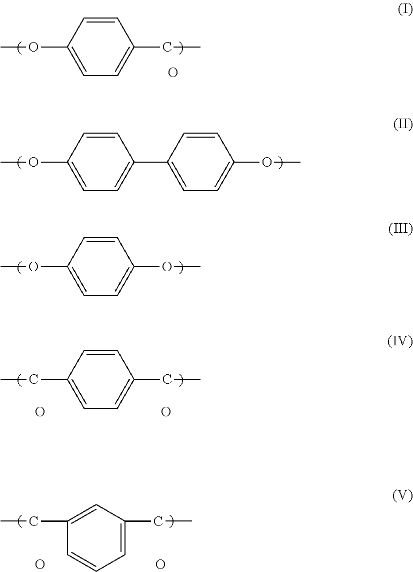

Structural unit (I) is generated from p-hydroxybenzoate. Structural unit (II) is generated from 4,4′-dihydroxy biphenyl. Structural unit (III) is generated from hydroquinone. Structural unit (IV) is generated from terephthalic acid. Structural unit (V) is generated from isophthalic acid.

It is preferable that structural unit (I) is contained by 65 to 80 mol % to total of (I), (II) and (III). To decrease gas generation, the lower limit is preferably 68 mol % or more. From a viewpoint of toughness, the upper limit is preferably 78 mol % or less.

It is preferable that structural unit (II) is contained by 55 to 85 mol % to total of (II) and (III). To decrease gas generation, the lower limit is preferably 60 mol % or more, and is most preferably 70 mol % or more. From a viewpoint of toughness, the upper limit is preferably 82 mol % or less, and most preferably 80 mol % or less.

It is preferable that structural unit (IV) is contained by 50 to 95 mol % to total of (IV) and (V). To decrease gas generation, the lower limit is preferably 55 mol % or more, and is most preferably 60 mol % or more. From a viewpoint of toughness, the upper limit is preferably 85 mol % or less, and most preferably 75 mol % or less.

It is preferable that the total of (II) and (III) is substantially equimolar to the total of (IV) and (V). “Substantially equimolar” means that structural units constituting polymer main chain except for the terminal are equimolar while they may not be equimolar when including the other structural units constituting the terminal. To adjust the terminal group of polymer, it is possible that dicarboxylic acid component or dihydroxy component is excessively contained.

The content of each structural unit in liquid crystalline polyester resin (A) can be calculated by the following process. First, the liquid crystalline polyester resin is sampled in test tube for NMR (Nuclear Magnetic Resonance) and is dissolved in solvent (e.g., pentafluorophenol/deuterated tetrachloro ethane—d₂ mixture solvent) capable of dissolving liquid crystalline polyester resin to perform ¹H-NMR spectrum measurement. The content of each structural unit can be calculated from the peak area ratio derived from each structural unit.

From viewpoints of workability and fluidity, it is preferable that liquid crystalline polyester resin (A) has a melting point of 300 to 350° C. From a viewpoint of workability, the lower limit is preferably 310° C. or more, and is specifically preferably 320° C. or more. From a viewpoint of fluidity, it is preferable that the upper limit is 340° C. or less, and specifically preferably 330° C. or less. The melting point within the preferable range can suppress resolved gas generation at the time of processing as exhibiting sufficient fluidity.

The melting point (Tm) of liquid crystalline polyester resin (A) can be measured by the following method. The differential calorimetry is performed with liquid crystalline polyester resin to observe endothermic peak temperature (Tm₁) at temperature-raising condition of 40° C./min from room temperature. After keeping the temperature at Tm₁+20° C. for 5 minutes, the temperature is once cooled down to room temperature at temperature-lowering condition of 20° C./min. Then, the temperature is raised again at temperature-raising condition of 20° C./min to observe endothermic peak temperature (Tm₂) regarded as melting point (Tm).

It is preferable that liquid crystalline polyester resin (A) has a melt viscosity of 1 to 100 Pa·s. From a viewpoint of workability, the lower limit is preferably 3 Pa·s or more, and specifically preferably 5 Pa·s. From a viewpoint of fluidity, the upper limit is preferably 50 Pa·s or less, and specifically preferably 30 Pa·s or less. The melt viscosity is measured by a Koka type flow tester at the temperature of 10° C.+melting point of the liquid crystalline polyester resin under a condition of shear speed of 1,000/s.

Liquid crystalline polyester resin (A) can be prepared by a well-known polycondensation method of polyester. For example, the following production methods are preferable to produce the above-described liquid crystalline polyester resin consisting of structural units (I), (II), (III), (IV) and (V):
(1) A production method of liquid crystalline polyester by a deacetylating polycondensation reaction from p-acetoxy benzoate, 4,4′-diacetoxy biphenyl, diacetoxy benzene, terephthalic acid and isophthalic acid.
(2) A production method of liquid crystalline polyester by a deacetylating polycondensation reaction after acylating phenolic hydroxyl group by reacting acetic anhydride with p-hydroxy benzoate, 4,4′-dihydroxy biphenyl, hydroquinone, terephthalic acid and isophthalic acid.
(3) A production method of liquid crystalline polyester by a dephenol polycondensation reaction from phenyl ester of p-hydroxy benzoate, 4,4′-dihydroxy biphenyl, hydroquinone and diphenyl ester of terephthalic acid and isophthalic acid.
(4) A production method of liquid crystalline polyester by a dephenol polycondensation reaction by adding 4,4′-dihydroxy biphenyl and an aromatic dihydroxy compound such as hydroquinone after making each diphenyl ester by reacting a predetermined amount of diphenyl carbonate with p-hydroxy benzoate and an aromatic dicarboxylic acid such as terephthalic acid and isophthalic acid.

When the liquid crystalline polyester resin is produced by the deacetylating polycondensation reaction, it is preferable to employ a melt polymerization method completing the polycondensation reaction by reacting the liquid crystalline polyester resin under reduced pressure at a temperature high enough to melt the liquid crystalline polyester resin. For example, the above-described liquid crystalline polyester resin consisting of structural units (I), (II), (III), (IV) and (V) can be produced by a method finishing the polycondensation reaction under reduced pressure at a temperature raised to the melting point of the liquid crystalline polyester resin after heating to acetylate hydroxy group in nitrogen gas atmosphere as stirring a predetermined amount of a mixture of p-hydroxy benzoate, 4,4′-dihydroxy biphenyl, hydroquinone, terephthalic acid, isophthalic acid and acetic anhydride, contained in a reaction container having a stirring blade and a distilling tube with a discharge outlet at the bottom.

The obtained polymer can be discharged as a strand from the discharge outlet provided at the bottom of the reaction container under a pressure of approximately 1.0 kg/cm² (0.1 MPa) at a temperature high enough to melt it. To produce uniform polymer, it is preferable to employ the melt polymerization method capable of obtaining excellent polymer and generating less amount of gas.

Although the polycondensation reaction of the liquid crystalline polyester resin can be performed without a catalyst, it is possible to use metal compound such as tin (II) acetate, tetrabutyl titanate, potassium acetate, sodium acetate, antimony trioxide and metal magnesium.

Liquid crystalline polyester (A) may contain two or more kinds of liquid crystalline polyester.

Hydrophobic surfaced spherical silica (B) is spherical silica having a water contact angle of 60° or more. It is preferable that the contact angle is 70° or more, and is more preferably 90° or more. Such a contact angle within the range can prevent a boundary separation at the time of sliding because of high affinity between silica surface and the liquid crystalline polyester resin capable of stabilizing the interface.

The contact angle is preferably 150° or less, and is more preferably 130° or less. The contact angle of more than 150° might worsen the affinity to resin adversely.

A hydrophilic silica which is general silica or treated with general coupling agent such as amino silane and epoxy silane has a contact angle of less than 60°.

The contact angle can be observed from the side as an angle between a silica plate surface and a tangent line of lower outline of beading, after dropping water onto a plate made by compressing hydrophobic surfaced spherical silica (B) according to JIS R 3257:1999.

Hydrophobic surfaced spherical silica (B) can be prepared by treating the surface of spherical silica with a compound having hydrophobic group such as phenyl group, substituted phenyl group and alkyl fluoride.

The hydrophobic group is preferably the phenyl group or the substituted phenyl group. It is more preferably an alkoxy phenyl group, and is further preferably methoxyphenyl group or ethoxy phenyl group. When it has such a hydrophobic group, affinity with the liquid crystalline polyester can stabilize interface of the spherical silica with the liquid crystalline polyester to stably achieve a good sliding characteristic.

The compound having such a hydrophobic group may be a coupling agent such as silane coupling agent and titanium coupling agent. It is preferable to employ the silane coupling agent from viewpoints of usability cost.

The silane coupling agent has affinity or reactivity to inorganic materials, and usually has a structure of a silicon atom chemically coupled with hydrolytic group.

The silane coupling agent may be t-butyl diphenyl chlorosilane, phenyl trimethoxy silane, diphenyl dimethoxy silane, methoxyphenyl silane, ethoxyphenyl silane or the line. It is preferable to employ the methoxyphenyl silane.

A single coupling agent as described above may be used although two or more kinds thereof can be used. It is possible that the coupling agent is dissolved in solvent to contact silica for the surface treatment.

The surface treatment can be performed with organic solvent selected according to the coupling agent. It is possible to use two or more kinds of the organic solvents. Further, inorganic microparticles can be washed out of the spherical silica after the surface treatment with organic solvent selected according to the coupling agent. After the coupling agent treatment, heat treatment may be performed for fixation.

There may be phenyl group or substituted phenyl group on the surface of perfectly-spherical silica after the surface treatment. It is preferable to employ a surface-treated spherical silica having such a functional group on the surface so that sliding characteristic can improve with stable interface to resin.

Hydrophobic surfaced spherical silica (B) means a silica particle having a sphericity of 0.60 or more made from spherical initial particle. From viewpoints of high density filling and dispersion to resin, it is preferable that the sphericity is 0.85 or more. It is preferably 0.90 or more, and further preferably 0.92 or more.

The sphericity within such a range can reduce flow resistance for injection mold to provide a molded product having a high surface smoothness and small coefficient of friction.

Sphericity is calculated by the following formula using area and boundary length obtained from a two-dimensional image of the particle:

(Sphericity)={4π×(area)/(boundary length)²}.

The perfectly-spherical silica has a sphericity of almost 1. Sphericity can be calculated by the above-described formula using averages of area and boundary length of silica of 100 mg dispersed in water measured with two-dimensional images of randomly-selected 1,000 pieces of particles with an image processing apparatus (Sysmex Corporation: FPIA-3000).

It is preferable that the hydrophobic surfaced spherical silica has a monomodal particle diameter distribution and a number average particle diameter of 0.1 to 1.0 μm, preferably 0.3 to 0.7 μm. The particle diameter distribution within such a range can improve sliding characteristic.

The average particle diameter can be measured by a laser diffraction-type particle size distribution meter. The perfectly-spherical silica made by burning in a predetermined condition contains nanometer-sized microparticles which cannot be detected by the laser diffraction-type particle size distribution meter. Such an undetectable particles of extremely small amount would not affect the measurement. The monomodal particle diameter distribution means a monomodal (single peak) distribution measured with a laser diffraction-type particle size distribution meter and plotted with horizontal axis of particle diameter and vertical axis of frequency.

It is preferable that rough particles of 5 μm or more are contained by 100 ppm, preferably 50 ppm. To remove the rough particles, it is possible to employ a filtration method to filter the slurry or a cutting method to cut rough particles which precipitate early by the air-layer precipitation method. The rough particles contained by 100 ppm or less can improve sliding characteristic.

We found that the spherical silica having a predetermined average particle diameter with such a hydrophobic surface has a good affinity with liquid crystalline resin to form liquid crystalline resin composition so that sliding characteristic and impact durability can be specifically improved by providing skin layer of molded product with some aggregates formed and laid out with a high primary coagulation power. The aggregates arranged on the skin layer of molded product can contribute to improvement of adhesion strength to achieve both sliding and adhesion which are opposing to each other from a viewpoint of roughness.

The aggregate has a length of 10 μm or more, preferably 15 μm or more. It is preferable that the aggregates are close to each other at a density of 8 units/100 μm, preferably 10 units/100 μm².

The size and number of the aggregates can be measured with a scanning electron microscope after cutting a cross section of composition with a microtome into 100 μm. The aggregate means collective particles which are not monodispersed.

The liquid crystalline polyester of 100 parts by weight contains the spherical silica of 10 to 45 parts by weight, preferably 20 to 45 parts by weight. The content within the range can achieve both sliding characteristic and adhesive characteristic. The content of 25 to 44 parts by weight can form a strong sequential aggregated structure of spherical silica on the skin layer of molded product to specifically improve impact durability. The content of less than 10 parts by weight might not improve the sliding characteristic while the content of more than 45 parts by weight might improve the adhesive strength.

It is preferable that ethylene/glycidyl methacrylate copolymer (C) of 1 to 2.5 parts by weight is added to the resin composition of 100 parts by weight consisting of liquid crystalline polyester resin (A) and hydrophobic surfaced spherical silica (B) so that sliding characteristic can improve.

The content of ethylene/glycidyl methacrylate copolymer (C) is preferably 1.5 to 2.5 parts by weight, and is more preferably 2.0 to 2.5 parts by weight to the resin composition of 100 parts by weight consisting of liquid crystalline polyester resin (A) and hydrophobic surfaced spherical silica (B). The content within such a range can greatly improve the slidability.

Ethylene/glycidyl methacrylate copolymer (C) is made by copolymerizing glycidyl methacrylate of 1 to 50 wt % to ethylene. It is preferable to copolymerize the glycidyl methacrylate of 1 to 12 wt %, preferably 2 to 6 wt %. The copolymerization of the glycidyl methacrylate of such amount can greatly improve the sliding characteristic.

It is possible that ethylene/glycidyl methacrylate copolymer (C) is copolymerized with 40 wt % or less of unsaturated monomer such as vinyl ether, vinyl ester like vinyl acetate or propionate vinyl, ester of methyl, ethyl or propyl acrylate and methacrylate, acrylonitrile, styrene or the like. From a viewpoint of heat resistance, it is preferable to employ the methyl acrylate.

It is preferable that the methyl acrylate of 30 wt % or less is copolymerized to improve sliding characteristic and adhesive characteristic.

To the extent of not spoiling the desired effect, a predetermined characteristic may be given by adding another thermoplastic resin (fluororesin or the like) or a general additive such as heat stabilizer (hindered phenol, hydroquinone, phosphite, substitution product thereof or the like), ultraviolet absorber (resorcinol, salicylate, benzotriazole, benzophenone or the like), release agent (montanic acid, salt thereof, half ester thereof, stearyl alcohol, stearamide, polyethylene wax or the like), coloring agent containing dye (nigrosin or the like) or pigment (cadmium sulfide, phthalocyanine, carbon black or the like), plasticizer, flame retardant and auxiliary flame retardant.

It is preferable that the liquid crystalline polyester resin composition is produced by melt-kneading employing a well-known method. Melt-kneading may be performed with a Banbury mixer, a rubber roll machine, a kneader, a single or a twin screw extruder or the like. To control number average length of filler fiber of the liquid crystalline polyester resin composition, it is preferable to employ an extruder. It is more preferable to employ the twin screw extruder, preferably with an intermediate addition port. To add metal salt of higher fatty acid, it is preferable to blend it with pellets after melt-kneading extrusion. Such a blend can improve molding workability greatly. To blend the metal salt of higher fatty acid with the pellets, a tumbler mixer, a ribbon blender or the like may be used. It is possible that the metal salt of higher fatty acid is melt-kneaded with the liquid crystalline resin or other additives in the twin screw extruder.

The liquid crystalline polyester resin composition is formed into a molded product by an well-known forming method, preferably injection molding method. The injection molding can specifically improve slidability by a skin layer on the surface of molded product on which an arrayed spherical silica is buried in liquid crystalline polyester resin.

Thus obtained molded product excellent in sliding characteristic and adhesive characteristics can be applied to precision component parts having sliding part or adhesion part. The molded product is preferably applied to component parts having lens supporting section such as lens barrel or lens holder constituting lens unit of camera module, sleeve or base constituting actuator unit, housing or the like.

### EXAMPLES

The effects of our compositions and products will be explained with reference to examples. “%” and “part” shown in the Examples are indicated by weight unless there is a specific note. Each characteristic shown in the Examples is evaluated by the following method.

### Contact Angle of Spherical Silica

Silica is compressed with a tablet production device and molded as a tablet. The contact angle of the tablet to plane water is measured according to JIS R 3257:1999.

### Sphericity of Perfectly-Spherical Silica

Sphericity is calculated by the following formula using averages of area and boundary length of silica of 100 mg dispersed in water measured with two-dimensional images of randomly-selected 1,000 pieces of particles with an image processing apparatus (Sysmex Corporation: FPIA-3000):

(Sphericity)={4π×(area)/(boundary length)²}.

### Average Particle Diameter and Particle Size Distribution (Peak Modality)

Average particle diameter is measured with a laser diffraction-style particle size distribution meter. The number of peaks of 60% or more to the maximum value of frequency is counted in the distribution plotted with horizontal axis of particle diameter and vertical axis of frequency. The distribution including a single peak is regarded as monomodal while the distribution including two peaks is regarded as bimodal. Further, concentration of rough particles having a diameter of 5 μm or more to the total particles is calculated.

### Sliding Characteristic

Coefficient of friction: The coefficient of dynamic friction of cylindrical molded product (having 1 cm² of end circular part) made of liquid crystalline polyester resin composition is measured with Suzuki-type abrasion tester (FRICTION AND WEAR TESTER MODEL EFM-III-EN made in ORIENTEC Co., Ltd.). (The coefficient of friction is read off when the scale is stable 1 to 5 minutes later from the start of measurement at P=4.0 kg and V=50 cm/min). The counterpart of friction is a metal plate (made of S45C material of 30 mm length, 30 mm width and 3 mm thickness). The smaller the dynamic coefficient of friction is the better the quality is.

Abrasion loss: Weight reduction of cylindrical molded product is evaluated after 20,000 rounds in the above-described condition. The smaller the weight reduction is the better the quality is.

### Adhesion Characteristic

A reed-shaped test piece of 127 mm×12.7 mm×3.2 mm thickness is prepared by injection molding of liquid crystalline polyester resin composition obtained in each Example or Comparative Example with FANUC ROBOSHOT α-30C (made by FANUC CORPORATION) at mold temperature of 90° C., injection speed of 100 mm/s and cylinder temperature of 10° C.+melting point of the liquid crystalline polyester resin. The prepared molded product is divided equally among three in the longitudinal direction. One component curing-type epoxy resin is applied to an area of 10 mm×12.7 mm of the center part overlapped by both end parts to cure the epoxy resin as clipped for 1 hour at 120° C. After curing, the peel strength is measured by pushing the center part loaded at the center and supported by both two ends at 23° C. and 50 RH %.

### Impact Durability

A plate of 20 g weight is dropped from 20 cm height onto a plate of indenter placed on the same molded product as prepared in the above-described explanation of adhesion characteristic. The surface of the molded product after the test is observed with an optical microscope at magnification of 200 times to evaluate the number of drops enough to crack. The more the number of drops is the better the quality is.

### Dispersion of Perfectly-Spherical Silica

The cross section of the same molded product as prepared in the above-described explanation of adhesion characteristic is cut with a microtome to observe the cut section with a scanning electron microscope. The number of aggregates is counted by observing 10 images of 100 μm square. A number average major axis is calculated among the counted aggregates.

Components (A) to (C) used in the Examples will be shown as follow.

### (A) Liquid Crystalline Polyester Resin

### Reference Example 1: Synthesis of Liquid Crystalline Polyester Resin (A-1)

p-Hydroxybenzoate of 870 parts by weight, 4,4′-dihydroxy biphenyl of 327 parts by weight, hydroquinone of 89 parts by weight, terephthalic acid of 292 parts by weight, isophthalic acid of 157 parts by weight and acetic anhydride of 1,367 parts by weight (1.03 equivalent of total phenolic hydroxyl groups) were mixed in a reaction container of 5 Liter with a stirring blade and distilling tube, and stirred in nitrogen gas atmosphere at 145° C. for 2 hours and then heated for 4 hours up to 320° C. Then, the polymerization temperature was kept at 320° C. for 1.0 hour to decrease pressure down to 1.0 mmHg (133 Pa). After the reaction was continued for 90 minutes, the polymerization was completed when the stirring torque reached 15 kg·cm. Next, inside of reaction container was pressurized to 1.0 kg/cm² (0.1 MPa) to discharge strand of polymer through a spinneret having a circular discharge port of 10 mm diameter. The strand was pelletized with a cutter to obtain liquid crystalline polyester resin (A-1).

The liquid crystalline polyester resin (A-1) was subjected to a composition analysis to find that structural unit (I) derived from p-hydroxybenzoate had proportion of 70 mol % to the total of structural unit (I) derived from p-hydroxybenzoate, structural unit (II) derived from 4,4′-dihydroxy biphenyl and structural unit (III) derived from hydroquinone. Structural unit (II) derived from 4,4′-dihydroxy biphenyl had proportion of 70 mol % to the total of structural unit (II) derived from 4,4′-dihydroxy biphenyl and structural unit (III) derived from hydroquinone. Structural unit (IV) derived from terephthalic acid had proportion of 65 mol % to the total of structural unit (IV) derived from terephthalic acid and structural unit (V) derived from isophthalic acid. The total of structural unit (II) derived from 4,4′-dihydroxy biphenyl and structural unit (III) derived from hydroquinone had proportion of 23 mol % to the total of all the structural units while the total of structural unit (IV) derived from terephthalic acid and structural unit (V) derived from isophthalic acid had proportion of 23 mol % to the total of all the structural units. Liquid crystalline polyester resin (A-1) had a melting point (Tm) of 314° C. The melt viscosity of 20 Pa·s was measured with Koka-type flow tester (orifice 0.5φ×10 mm) at 324° C. and shear speed of 1,000/s.

### Reference Example 2: Synthesis of Liquid Crystalline Polyester Resin (A-2)

p-Hydroxybenzoate of 932 parts by weight, 4,4′-dihydroxy biphenyl of 251 parts by weight, hydroquinone of 99 parts by weight, terephthalic acid of 284 parts by weight, isophthalic acid of 90 parts by weight and acetic anhydride of 1,252 parts by weight (1.09 equivalent of total phenolic hydroxyl groups) were mixed in a reaction container of 5 Liter with a stirring blade and distilling tube, and stirred in nitrogen gas atmosphere at 145° C. for 1 hour, and then heated from 145° C. to 270° C. of jacket temperature at average temperature-raising speed of 0.68° C./min and further heated from 270° C. to 350° C. at average temperature-raising speed of 1.4° C./min. The temperature-raising time was four hours. Then, the polymerization temperature was kept at 350° C. for 1.0 hour to decrease pressure down to 1.0 mmHg (133 Pa). After the reaction, the polymerization was completed when the stirring torque reached 10 kg·cm. Next, inside of reaction container was pressurized to 1.0 kg/cm² (0.1 MPa) to discharge strand of polymer through a spinneret having a circular discharge port of 10 mm diameter. The strand was pelletized with a cutter to obtain liquid crystalline polyester resin (A-2).

The liquid crystalline polyester resin (A-2) was subjected to a composition analysis to find that structural unit (I) derived from p-hydroxybenzoate had proportion of 75 mol % to the total of structural unit (I) derived from p-hydroxybenzoate, structural unit (II) derived from 4,4′-dihydroxy biphenyl and structural unit (III) derived from hydroquinone. Structural unit (II) derived from 4,4′-dihydroxy biphenyl had proportion of 60 mol % to the total of structural unit (II) derived from 4,4′-dihydroxy biphenyl and structural unit (III) derived from hydroquinone. Structural unit (IV) derived from terephthalic acid had proportion of 76 mol % to the total of structural unit (IV) derived from terephthalic acid and structural unit (V) derived from isophthalic acid. The total of structural unit (II) derived from 4,4′-dihydroxy biphenyl and structural unit (III) derived from hydroquinone had proportion of 20 mol % to the total of all the structural units while the total of structural unit (IV) derived from terephthalic acid and structural unit (V) derived from isophthalic acid had proportion of 20 mol % to the total of all the structural units. Liquid crystalline polyester resin (A-2) had a melting point (Tm) of 325° C. The melt viscosity of 8 Pa·s was measured with Koka-type flow tester (orifice 0.5φ×10 mm) at 335° C. and shear speed of 1,000/s.

### (B) Spherical Silica

(B-1) Trimethoxy phenyl silane coupling surface-treated spherical silica “SC2500-SPJ” made by Admatechs Corporation (number average particle diameter 0.5 μtm (monomodal), sphericity 0.90, contact angle 113°, 5 ppm proportion of rough particle larger than 5 μm)
(B-2) Trimethoxy phenyl silane coupling surface-treated spherical silica “FEB75A-SP” made by Admatechs Corporation (number average particle diameter 15 μm (monomodal), sphericity 0.904, contact angle 112°, 96% proportion of rough particle larger than 5 μm)
(B′-1) Spherical silica “SO-C2” made by Admatechs Corporation (number average particle diameter 0.5 μm (without hydrophobic surface treatment, monomodal), sphericity 0.90, contact angle 19°, 120 ppm proportion of rough particle larger than 5 μm)

### (C) Ethylene/Glycidyl Methacrylate Copolymer

(C-1) Ethylene/glycidyl methacrylate=88/12 (wt %) copolymer: “BF-E” made by Sumitomo Chemical Co., Ltd.
(C-2) Ethylene/glycidyl methacrylate/methyl acrylate=67/6/27 (wt %) copolymer: “BF-7M” made by Sumitomo Chemical Co., Ltd.
(C-3) Ethylene/glycidyl methacrylate/methyl acrylate=70/3/27 (wt %) copolymer: “BF-7L” made by Sumitomo Chemical Co., Ltd.

### Examples 1-14, Comparative Examples 1-5

Using a twin screw extruder “TEX-44” (made by Japan Steel Works, Ltd.) of screw diameter of 44 mm with coaxially rotational vent, liquid crystalline polyester resin (A) and ethylene/glycidyl methacrylate copolymer (C) of amounts shown in Table 1 were fed from a hopper while spherical silica (B) of amount shown in Table 1 was fed through an intermediate feeding port. The cylinder temperature was set to 10° C.+melting point of liquid crystalline polyester resin (A) (which may be 10° C.+higher temperature of melting points in the two kinds of liquid crystalline polyester resins contained) to prepare pellets of liquid crystalline polyester resin composition by melt-kneading. Various characteristics of the pellets were evaluated. Test results are shown in Table 1.

TABLE 1

| | | | | Ethylene/ | | | | | | | |
|---|---|---|---|---|---|---|---|---|---|---|---|
| | | | | glycidylmethacrylate | | | | | | | |
| | | | | copolymer (C) | | | | | | | |
| | | Spherical silica (B) | | | part by weight | Sliding characteristic | | Adhesive | Impact | Dispersion state | |
| | Liquid | | part by weight | | based on 100 | Coefficient | | characteristic | durability | Average | |
| | crystalline | | based on 100 | | parts by weight | of dynamic | Abrasion | Peel | Durable | major | |
| | polyester | | parts by weight | | in total of A | friction | loss | strength | times | axis | Units |
| | resin (A) | Type | of A | Type | and B | — | wt % | MPa | Time | μm | unit/100 μm² |
| Example 1 | A-1 | B-1 | 26.5 | — | — | 0.12 | 0.018 | 6.000 | 300 | 15.0 | 10 |
| Example 2 | A-1 | B-1 | 10.5 | — | — | 0.13 | 0.032 | 5.700 | 200 | 12.0 | 8 |
| Example 3 | A-1 | B-1 | 34.5 | — | — | 0.14 | 0.028 | 5.800 | 400 | 17.0 | 13 |
| Example 4 | A-1 | B-1 | 43.5 | — | — | 0.14 | 0.028 | 5.800 | 600 | 19.0 | 20 |
| Example 5 | A-1 | B-1 | 45.0 | — | — | 0.14 | 0.028 | 5.800 | 500 | 18.0 | 15 |
| Example 6 | A-1 | B-1 | 26.5 | C-2 | 2.5 | 0.10 | 0.008 | 7.400 | 400 | 16.0 | 12 |
| Example 7 | A-1 | B-1 | 26.5 | C-2 | 1.2 | 0.12 | 0.010 | 6.800 | 380 | 15.0 | 11 |
| Example 8 | A-1 | B-1 | 26.5 | C-1 | 2.5 | 0.14 | 0.019 | 6.100 | 350 | 16.0 | 10 |
| Example 9 | A-1 | B-1 | 26.5 | C-3 | 2.5 | 0.13 | 0.013 | 6.500 | 320 | 15.0 | 10 |
| Example 10 | A-1 | B-1 | 45.0 | C-2 | 2.5 | 0.12 | 0.010 | 7.100 | 750 | 20.0 | 20 |
| Example 11 | A-1 | B-2 | 26.5 | — | — | 0.15 | 0.033 | 5.500 | 280 | 14.0 | 9 |
| Example 12 | A-1 | B-2 | 45.0 | — | — | 0.16 | 0.030 | 5.600 | 480 | 16.0 | 13 |
| Example 13 | A-2 | B-1 | 26.5 | — | — | 0.13 | 0.019 | 5.800 | 280 | 14.0 | 8 |
| Example 14 | A-2 | B-1 | 45.0 | — | — | 0.13 | 0.021 | 5.700 | 460 | 12.0 | 10 |
| Example 15 | A-2 | B-1 | 26.5 | C-2 | 2.5 | 0.11 | 0.006 | 7.600 | 350 | 14.0 | 11 |
| Example 16 | A-2/A-1 = | B-1 | 45.0 | C-2 | 2.5 | 0.10 | 0.002 | 7.800 | 800 | 22.0 | 21 |
| | 70/30 | | | | | | | | | | |
| Comparative | A-1 | B′-1 | 26.5 | — | — | 0.42 | 0.240 | 2.300 | 100 | 2.0 | 2 |
| Example 1 | | | | | | | | | | | |
| Comparative | A-1 | B-1 | 9.2 | — | — | 0.32 | 0.180 | 3.400 | 50 | 1.0 | 1 |
| Example 2 | | | | | | | | | | | |
| Comparative | A-1 | B-1 | 46.0 | — | — | 0.48 | 0.280 | 3.000 | 150 | 4.0 | 3 |
| Example 3 | | | | | | | | | | | |
| Comparative | A-1 | B′-1 | 26.5 | C-2 | 2.5 | 0.40 | 0.280 | 2.400 | 170 | 4.0 | 3 |
| Example 4 | | | | | | | | | | | |
| Comparative | A-2/A-1 = | B′-1 | 26.5 | C-2 | 2.5 | 0.38 | 0.260 | 2.500 | 180 | 3.0 | 2 |
| Example 5 | 70/30 | | | | | | | | | | |

As apparent from the results shown in Table 1, liquid crystalline polyester resin compositions in the Examples are excellent in sliding characteristic, adhesive characteristic and impact durability. According to Examples 1 and 11, the sliding characteristic is excellent when the spherical silica has a particle diameter within a predetermined range. According to Examples 6-10, 15 and 16, ethylene/glycidyl methacrylate copolymer can improve further the advantageous effects.

On the other hand, the spherical silicas which have never been treated for hydrophobic surface did not have such advantageous characteristics according to Comparative Examples 1, 4 and 5. Further, the content of more or less than the predetermined range cannot achieve an advantageous effect according to Comparative Examples 2 and 3.

### INDUSTRIAL APPLICATIONS

Our liquid crystalline polyester resin compositions are applicable to various gears, various cases, sensor, LED part, liquid crystal backlight bobbin, connector, socket, resistance, relay case, spool and base for relay, switch, coil bobbin, capacitor, variable capacitor case, optical pick-up, radiator, various terminal boards, transformer, plug, printed wiring board, tuner, speaker, microphone, headphone, small motor, magnetic head base, power module, housing, semiconductor, liquid crystal display part, FDD carriage, FDD chassis, HDD part, motor brush holder, parabolic antenna, electric/electronic parts represented by computer-related parts; VTR part, TV part (plasma, organic EL, liquid crystal), iron, hair dryer, rice cooker part, microwave oven part, acoustic part, audio equipment part such as audio, laser disc (registered trademark) and compact disk, home and office electric appliance part represented by illumination part, refrigerator part, and air-conditioner part, office computer-related part, telephone-related part, facsimile-related part, copier-related part, washing jig, various bearings such as oilless bearing, stern bearing and underwater bearing, machine-related part represented by motor part, lighter and typewriter, optical device represented by microscope, binoculars, camera, and watch or clock, precision instrument-related part, alternator terminal, alternator connector, IC regulator, potentiometer base for light dimmer, various valves such as exhaust gas valve, various fuel/exhaust/intake-related pipes, car/vehicle-related parts such as air-intake nozzle snorkel, intake manifold, fuel pump, engine coolant joint, carburetor main body, carburetor spacer, exhaust gas sensor, coolant sensor, oil temperature sensor, throttle position sensor, crankshaft position sensor, air flow meter, brake pad abrasion sensor, thermostat base for air-conditioners, motor insulator for air-conditioners, heating warm air flow control valve, brush holder for radiator motors, water pump impeller, turbine vane, wiper motor-related part, distributor, starter switch, starter relay, wire harness for transmissions, wind washer nozzle, air-conditioner panel switch board, coil for fuel-related electromagnetic valves, connector for fuses, ECU connector, horn terminal, electric equipment part insulation board, step motor rotor, lamp socket, lamp reflector, lamp housing, brake piston, solenoid bobbin, engine oil filter and ignition device case. Our liquid crystalline polyester resin composition is useful to provide a film for magnetic recording media films, and also useful to provide a sheet for door trim, bumper or buffer material of side frame, seat material, pillar, fuel tank, brake hose, nozzle of wind washer liquid, tube of air-conditioner refrigerant or the like. Our liquid crystalline polyester resin composition is suitable to provide a sliding component part such as camera module part, optical pickup lens holder and auto focus camera lens module.

Particularly, our liquid crystalline polyester resin composition and molded product excellent in sliding characteristic and adhesive characteristic can be applied to precision component parts having a sliding part. Our molded product is preferably applied to component parts having lens supporting section such as lens barrel or lens holder constituting lens unit of camera module, sleeve or base constituting actuator unit, housing or the like.

1-6. (canceled)

7. A liquid crystalline polyester resin composition comprising a hydrophobic surfaced spherical silica (B) of 10 to 45 parts by weight to a liquid crystalline polyester resin (A) of 100 parts by weight.

8. The liquid crystalline polyester resin composition according to claim 7, wherein the hydrophobic surfaced spherical silica (B) has a monomodal particle diameter distribution and a number average particle diameter of 0.1 to 1.0 μm.

9. The liquid crystalline polyester resin composition according to claim 7, wherein the hydrophobic surfaced spherical silica (B) comprises a spherical silica subjected to an alkoxy phenyl silane coupling treatment.

10. The liquid crystalline polyester resin composition according to claim 7, wherein an ethylene/glycidyl methacrylate copolymer (C) of 1 to 2.5 parts by weight is added to a resin composition of 100 parts by weight consisting of the liquid crystalline polyester resin (A) and the hydrophobic surfaced spherical silica. (B).

11. The liquid crystalline polyester resin composition according to claim 10, wherein the ethylene/glycidyl methacrylate copolymer (C) is made by copolymerizing glycidyl methacrylate of 2 to 6 wt %.

12. A molded product comprising the liquid crystalline polyester resin composition according to claim 7.

13. The liquid crystalline polyester resin composition according to claim 8, wherein the hydrophobic surfaced spherical silica (B) comprises a spherical silica subjected to an alkoxy phenyl silane coupling treatment.

14. The liquid crystalline polyester resin composition according to claim 8, wherein an ethylene/glycidyl methacrylate copolymer (C) of 1 to 2.5 parts by weight is added to a resin composition of 100 parts by weight consisting of the liquid crystalline polyester resin (A) and the hydrophobic surfaced spherical silica (B).

15. The liquid crystalline polyester resin composition according to claim 9, wherein an ethylene/glycidyl methacrylate copolymer (C) of 1 to 2.5 parts by weight is added to a resin composition of 100 parts by weight consisting of the liquid crystalline polyester resin (A) and the hydrophobic surfaced spherical silica (B).

16. A molded product comprising the liquid crystalline polyester resin composition according to claim 8.

17. A molded product comprising the liquid crystalline polyester resin composition according to claim 9.

18. A molded product comprising the liquid crystalline polyester resin composition according to claim 10.

19. A molded product comprising the liquid crystalline polyester resin composition according to claim 11.
